(19) United States
(12) Patent Application Publication
(10) Pub. No.: US 2017/0053209 A1
(43) Pub. Date: Feb. 23, 2017

(54) SYSTEM AND METHOD FOR MULTI-FACTORED-BASED RANKING OF TRIPS

(71) Applicant: Xerox Corporation, Norwalk, CT (US)

(72) Inventors: Eric Céret, Grenoble (FR); Stefania Castellani, Meylan (FR); Vassilissa Lehoux, Grenoble (FR)

(73) Assignee: Xerox Corporation, Norwalk, CT (US)

(21) Appl. No.: 14/831,326

(22) Filed: Aug. 20, 2015

(51) Int. Cl. G06N 5/04; G06Q 10/02

(52) U.S. Cl. CPC G06N 5/048; G06Q 10/02

(57) ABSTRACT

A trip-planning method and system employ a user profile for each user which includes the user's preferences for each of a plurality of transportation modes, user goals, and optionally user constraints on trips. Inferred user preference (resp. goal) values and stated user preference (resp. goal) values are aggregated using a coefficient which places more emphasis on stated goals/preferences that have been recently set. Candidate itineraries for a requested user trip that meet the user's constraints are ranked based on the aggregated goal and preference values and the costs/contributions of each itinerary to the respective goal/preference. A subset of the ranked itineraries may be output to the user for the user to select one for making the trip.

### BACKGROUND

The exemplary embodiment relates to trip planning and finds particular application in connection with a system and method for ranking trips based on personal factors.

Providing support for travelers in trip planning has been an active field of study. Systems have been designed to help travelers to define itineraries for their trips and to choose the corresponding transportation modes. However, such systems generally propose itineraries that are based on assumptions about a population of travelers. For example it may be assumed that travelers prefer shorter trips to longer ones. Data on collective traveler behavior may be used to rank itineraries of similar durations. For example, it may be determined that more travelers traveling between points A and B use the train than the bus.

However, travelers may have individual needs and preferences which differ from the collective behavior of a group of travelers. When presented with itineraries which do not meet the user's expectations, the user could choose to review a larger number of possible itineraries in order to find one that is of unique interest. However, travelers usually do not wish to expend a large amount of time reviewing different itineraries or are not made aware of alternatives which would better suit their interests. Additionally, users may not be aware of how their individual preferences should impact their choice of itineraries.

There remains a need for a system and method for assisting a user in planning a trip which is personalized to the individual user without unduly increasing the complexity of the selection process for the user or the system.

### INCORPORATION BY REFERENCE

The following references, the disclosures of which are incorporated herein by reference in their entireties, are mentioned:

U.S. Pat. No. 5,021,953, issued Jun. 4, 1991, entitled TRIP PLANNER OPTIMIZING TRAVEL ITINERARY SELECTION CONFORMING TO INDIVIDUALIZED TRAVEL POLICIES, by Webber, et al.

U.S. Pat. No. 6,622,084, issued Sep. 16, 2003, entitled TRAVEL ROUTE PLANNER SYSTEM AND METHOD, by Cardno, et al.

U.S. Pat. No. 7,925,540, issued Apr. 12, 2011, entitled METHOD AND SYSTEM FOR AN AUTOMATED TRIP PLANNER, by Orttung et al.

U.S. Pat. No. 8,494,771, issued Jul. 23, 2013, entitled JOURNEY PLANNING IN PUBLIC TRANSPORTATION NETWORKS, by Delling, et al.

U.S. Pat. No. 8,583,363, issued Nov. 12, 2013, entitled DETERMINING ALTERNATIVE ROUTES, by Abraham, et al.

U.S. Pat. No. 8,712,676, issued Apr. 29, 2014, entitled METHOD FOR COMPUTING AN ENERGY EFFICIENT ROUTE, by Hiestermann, et al.

U.S. Pat. No. 8,725,612, issued May 13, 2014, entitled PERSONALIZED REAL-TIME LOCATION-BASED TRAVEL MANAGEMENT, by Mundinger, et al.

U.S. Pat. No. 8,738,286, issued May 27, 2014, entitled TRANSIT ROUTING SYSTEM FOR PUBLIC TRANSPORTATION TRIP PLANNING, by Bast, et al.

U.S. Pub. No. 20130317742, published Nov. 28, 2013, entitled SYSTEM AND METHOD FOR ESTIMATING ORIGINS AND DESTINATIONS FROM IDENTIFIED END-POINT TIME-LOCATION STAMPS, by Ulloa Paredes, et al.

U.S. application Ser. No. 14/737,964, filed Jun. 12, 2015, entitled LEARNING MOBILITY USER CHOICE AND DEMAND MODELS FROM PUBLIC TRANSPORT FARE COLLECTION DATA, by Ulloa Paredes, et al.

U.S. application Ser. No. 14/450,628, filed Aug. 4, 2014, entitled EFFICIENT ROUTE PLANNING IN PUBLIC TRANSPORTATION NETWORKS, by Ulloa Paredes.

### BRIEF DESCRIPTION

In accordance with one aspect of the exemplary embodiment, a method for assisting a user in planning a trip includes receiving a request for a trip from a user. A user profile for the user is accessed, the user profile including user preferences for each of a plurality of transportation modes, user goals, and optionally user constraints on trips. The user preferences each include an inferred user preference value and, where stated, a stated user preference value. The user goals each include an inferred user goal value and, where stated, a stated user goal value. A set of candidate itineraries is built for the trip which each meets the user's constraints. The candidate itineraries each specify a respective set of the plurality of transportation modes. For each of the user preferences, the stated preference value, where stated, and the corresponding inferred preference value are aggregated to generate a weight for the preference. For each of the user goals, the stated goal value, where stated, and the inferred goal value are aggregated to generate a weight for the goal. For each of the candidate itineraries, a cost for each of the goals is computed. For each of the candidate itineraries, the itinerary is ranked based on the preference weights, goal weights, and the computed cost for each of the goals. Information on at least a subset of the ranked itineraries is output for enabling the user to select an itinerary for the trip.

One or more of the steps of the method may be implemented by a processor device.

In accordance with another aspect of the exemplary embodiment, a system for planning a trip includes a profile manager which manages, for each of a plurality of users, a respective user profile. The user profile includes the user's preferences for each of a plurality of transportation modes, user goals, and optionally user constraints on trips. The user preferences each include an inferred user preference value and, where stated, a stated user preference value, and the user goals each including an inferred user goal value and, where stated, a stated user goal value. A trip planner builds a set of candidate itineraries for a trip requested by one of the users, which meet the user's constraints on trips. The candidate itineraries each specify a respective set of the plurality of transportation modes. An aggregation component, for each of the user preferences, aggregates the stated preference value, where stated, and the inferred preference value to generate a weight for the preference and for each of the user goals, aggregates the stated goal value, where stated, and the inferred goal value to generate a weight for the goal. A ranking component ranks the candidate itineraries for each of the candidate itineraries based on the preference weights, goal weights, and a computed cost for each of the goals. A representation generator outputs information on at least a subset of the ranked itineraries for enabling the user to select an itinerary for the trip. A processor implements the profile manager, trip planner, aggregation component, ranking component, and representation generator.

In accordance with another aspect of the exemplary embodiment, a method includes providing for a user to state preference values for each of a plurality of transportation modes and providing for the user to state goal values for each of a plurality of goals to which the transportation modes employed in a trip itinerary contribute differently. Optionally, providing for the user to state a constraint for at least one of the transportation modes. Optionally, providing for the user to state other itinerary impacting constraints (e.g. wheel chair usage) or physical fitness information (e.g. age, weight, walking speed). Generating a user profile for the user, the user profile including user preferences for each of a plurality of transportation modes, user goals, and optionally user constraints, the user preferences each including an inferred user preference value and, where stated, the stated user preference value, and the user goals each including an inferred user goal value and, where stated, the stated user goal value. The inferred user goal values and inferred user preference values are based on prior user behavior. For each of a set of candidate itineraries for a trip, the candidate itinerary is ranked. The ranking includes computing a utility function which takes into account the stated and inferred preferences and stated and inferred goals and coefficients which place a weight on the inferred goals and inferred preferences as a function of a duration since the respective goal or preference was last stated. Information based on the ranking is output.

One or more of the steps of the method may be performed by a processor device.

### BRIEF DESCRIPTION OF THE DRAWINGS

FIG. 1 is a functional block diagram of a trip planning system in accordance with one aspect of the exemplary embodiment;

FIG. 2 is a flow diagram illustrating a trip planning method in accordance with another aspect of the exemplary embodiment;

FIG. 3 illustrates a user profile; and

FIG. 4 illustrates an exemplary method for aggregation of multiple objective functions in an exemplary utility function in the method of FIG. 2; and

FIG. 5 summarizes the computation of the utility function in the method of FIG. 4.

### DETAILED DESCRIPTION

Aspects of the exemplary embodiment relate to a system and method that personalizes trip planning for a user based on a set of personal factors that are relevant to the user when organizing trips.

The personalized method takes into account a set of user criteria, such as the user's preferences, goals, and constraints, in connection with a set of trip variables, such as transportation modes, number of transfers, times, and conditions.

Some of the user criteria can be stated by the user. Some of the user criteria may be inferred (learned) by the system based on the user's prior behavior. The system may also provide specific tools for dealing with exceptional situations.

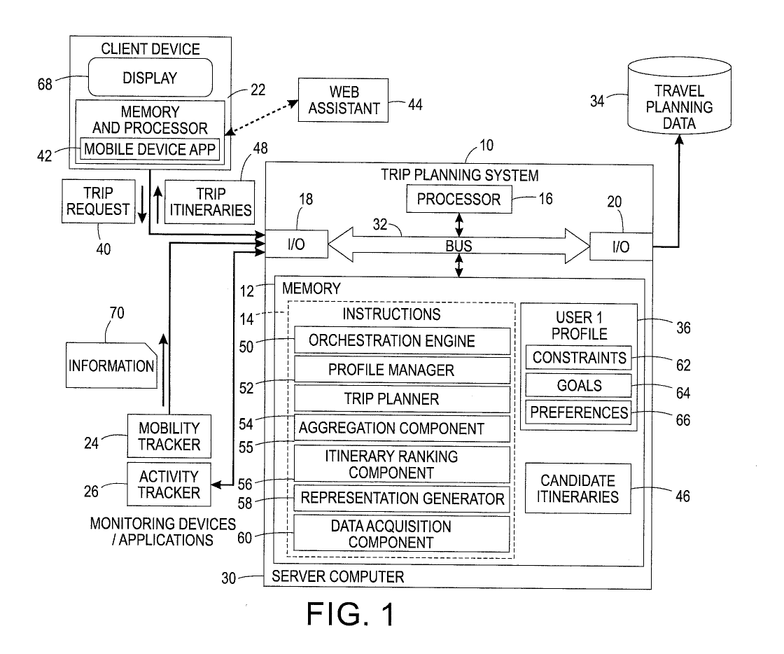

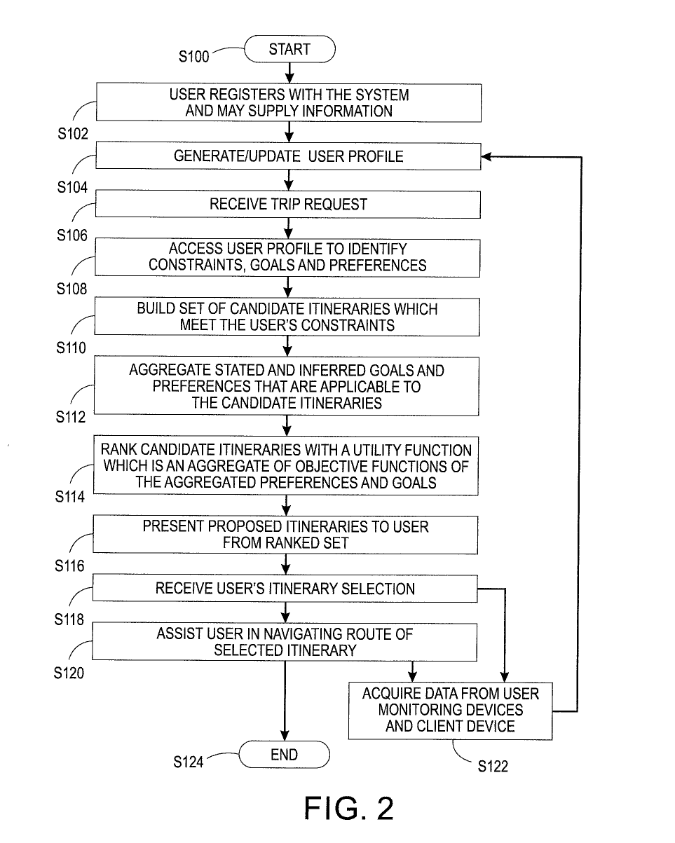

With reference to FIG. 1, a trip planning system 10 is illustrated in an operating environment. The system 10 includes memory 12 which stores instructions 14 for performing the method illustrated in FIG. 2 and a processor 16 in communication with the memory for executing the instructions. One or more input/output devices 18, 20 allow the system to communicate with external devices, such as the illustrated client computing device 22 and one or more user monitoring devices 24, 26, via wired or wireless connections 28, such as the Internet. The system 10 may be hosted by one or more computing devices, such as the illustrated server computer 30. Hardware components 12, 16, 18, 20 of the system are communicatively connected by a data/control bus 32.

The system 10 has access to travel planning data 34, such as route plans for one or more public transportation services (e.g., bus, tram, train, plane, etc.), time schedules for the public transportation services, maps for planning independent travel routes, such as walking, personal vehicle (e.g., car), and/or bicycle, and the like. The travel planning data 34 may be stored in one or more local and/or remote databases and/or be accessible via one or more websites. The system and method make use of a user profile 36, which may be stored in local or remote memory. The user profile models information on the particular user's criteria, such as personal preferences, personal goals, and constraints.

The system 10 receives as input a request 40 for planning a trip for a given user, which may specify a departure point D and an arrival point A. The departure point and arrival point may be input in any suitable form, such as geolocation (e.g., in the case of the departure point being the user's current location), address, point on a map, identifier of previously identified location (e.g., “home,” “work”), or the like. The request 40 may be generated with a mobile device application 42 or a web assistant 44 hosted by or accessed by the client device 22. The trip planning system 10 builds a list of one or more candidate itineraries 46 for the trip from D to A, taking into account the user's preferences, goals, and constraints, and may output one or more of the most highly ranked itineraries 48 to the user for review.

The illustrated instructions 14 are described in terms of a set of components 50, 52, 54, 56, 58, 60, which may be hosted on the same or different computing devices. These components may be in the form of software implemented by hardware, such as processor device 16. The components include an orchestration engine 50, which oversees activities of the other components 52, 54, 56, 58, 60.

A profile manager 52 maintains (generates and updates) a user profile 36 for each user of the system and accesses the current user profile 36 to extract information for planning the requested trip 40.

A trip planner 54 receives, as input, constraint information 62 which has been extracted from the user profile 36 and, given the departure point and arrival point, accesses the travel planning data 34 and computes a set of candidate itineraries 46 and their corresponding transportation modes, taking into account the constraints 62 for the user, for completing the trip between the specified departure and arrival points. Each candidate itinerary includes a sequence of segments to be followed in a predefined order, each segment being associated with a respective transportation mode to be used for that segment (as well as information on the particular vehicle which is being used, if appropriate, such as “bus 21 from Y to Y” or the 8.15 train from X to Y) and a predicted duration of the segment.

The trip planner 54 can be configured similarly to that described in above-mentioned U.S. application Ser. No. 14/450,628. See, also, F. Roulland, et al, “Learning mobility user choice and demand models from public transport fare collection data,” Intelligent Transport Systems, 21st World Congress, Apr. 8, 2015. As will be appreciated, the trip planner 54 may have a set of internal constraints and criteria that are used in identifying candidate itineraries, such as “no itinerary may be more than X times the time of the shortest”, “no itinerary may have more than Y transfers”, “walking/biking times in excess of Z minutes are excluded”, and so forth, which may be a function of the averages for travelers in that area. The trip planner may also be configured to identify candidate itineraries using a range of different transportation modes so that user preferences and goals can be more readily accommodated. For example, the trip planner may provide candidate itineraries which include, amongst them, at least two or at least three or at least four different transportation modes. At least one or more of the itineraries may use a different combination and/or sequence of transportation modes from one or more or all other candidate itineraries. At least one or more of the itineraries may make use of at least two or at least three different transportation modes. At least three or at least four or at least five or at least ten candidate itineraries may thus be generated for the trip (assuming that the trip planner is able to identify that number).

An aggregation component 55 aggregates for each goal and preference relevant to the candidate itineraries, the user's stated and inferred values for the respective goal or preference to generate a respective preference weight or goal weight.

A ranking component 56 ranks the candidate itineraries 46, based on the computed weights for the user's goals 64 and preferences 66 and computed costs for the goals and contributions for the preferences.

A representation generator 58 generates information 48 on the top ranked itineraries, e.g., in the form of a representation of a set of one, two or more top-ranked itineraries which the user can scroll through or otherwise peruse. The information 48 is sent to the client device for presentation to the user, e.g., by display on an associated display device 68 and/or audibly via a speaker device. A data acquisition component 60 collects information 70 from monitoring devices 24 and 26 and from client device 22 and uses the information to generate or update inferred preferences and goals for the user profile 36.

The computer system 10 may include one or more computing devices 30, such as a PC, such as a desktop, a laptop, palmtop computer, portable digital assistant (PDA), server computer, cellular telephone, tablet computer, pager, combination thereof, or other computing device capable of executing instructions for performing the exemplary method.

The memory 12 may represent any type of non-transitory computer readable medium such as random access memory (RAM), read only memory (ROM), magnetic disk or tape, optical disk, flash memory, or holographic memory. In one embodiment, the memory 12 comprises a combination of random access memory and read only memory. In some embodiments, the processor 16 and memory 12 may be combined in a single chip. Memory 12 stores instructions for performing the exemplary method as well as the processed data 36, 46.

The network interface 18, 20 allows the computer to communicate with other devices via a computer network, such as a local area network (LAN) or wide area network (WAN), or the internet, and may comprise a modulator/demodulator (MODEM) a router, a cable, and/or Ethernet port.

The digital processor device 16 can be variously embodied, such as by a single-core processor, a dual-core processor (or more generally by a multiple-core processor), a digital processor and cooperating math coprocessor, a digital controller, or the like. The digital processor 16, in addition to executing instructions 14 may also control the operation of the computer 30.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

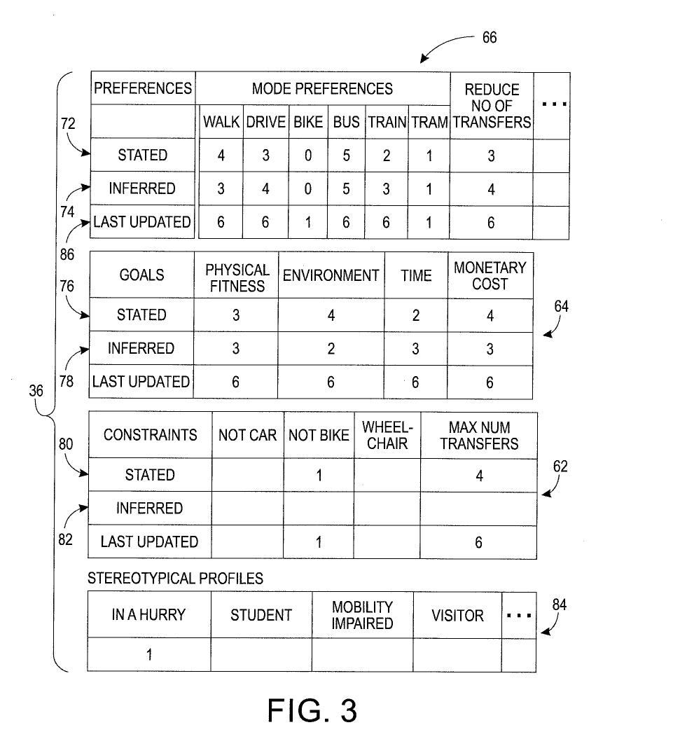

As illustrated in FIG. 3, the user profile 36 may include some or all of the following information:

1. Preference information 66: the user's preferences in relation to the use of the different potential transportation modes and the number of transfers. Transportation modes considered may include some or all of: walking, driving (e.g., by user's personal vehicle), tram, bicycle, train, plane, and boat, for example, depending on the modes available in the location. The transportation modes may include at least one public transportation mode (e.g., bus tram, or train) and at least one personal transportation mode (e.g., car, bicycle, walk). One or more of the transportation modes may be powered by a motor which directly or indirectly results in pollution CO2 production, such as a diesel or electric powered bus, while one or more modes of transport may be human powered, such as walk and bicycle. Some of the modes of transport may be associated with a higher monetary cost than others, for example, the bus may be cheaper than the train, although this may also be a function of the ticket price for particular trips.

Preferences for the modes may be stated by the user (stated preferences 72) and/or inferred by the system (inferred preferences 74). The inferred preferences 74 may be computed by the system based solely on information other than that collected from the user for the stated preferences 72. In some embodiments, the stated preferences may be stated by the user using numerical or other ratings, e.g., using numbers in a given numerical range (such as a 0-5 rating with 5 being the most preferred and 0 the least preferred). In other embodiments, the user may provide textual preferences, such as “I like using the tram”, or “I really don't like using the bus,” which are processed by the system to identify corresponding numerical ratings for the stated preferences. The inferred preferences 74 reflect the choices made by the user and are derived from the user's prior actions. These may include the transportation modes selected by the user for prior trips planned by the system and/or the tracked paths inferred from data collected from the monitoring devices 24, 26. Stated and inferred preferences can thus be represented on the same scale, e.g., as numbers between 0 (“Absolutely don't want to do this”) and 5 (“Like very much doing this”). A combination of stated and inferred preference values can be employed in order to present the most accurate list of candidate itineraries 46. For instance, if the user declares that she does not want to use buses, itineraries involving buses could be excluded from the list of possible options 46. However, the user may not like using the bus but still accept using it. Thus, bus options may appear among the candidate itineraries but are more likely to be lower ranked than other itineraries.

2. Goals 64: these may include the stated and inferred goals (objectives) 76, 78 that the user may have, such as some or all of: increasing physical activity/fitness, e.g., over a given period of time, reducing environmental impact, saving time, and saving money. For the stated goals 76, a number of possible goals may be offered to the user and each goal may be modeled as a number in a given numerical range, e.g., between 0 and 5, where 0 indicates that the user has not defined the importance of the goal, 1 means that this goal is not important, and 5 means that the goal is very important to the user. Inferred goals 78 are based on a prediction of the user's goals by the profile manager 52. For example, the user may declare that she wants to reduce her environmental impact (e.g., by reducing CO₂ emitted as a function of her trips), which is given a high ranking in her stated goals 76. However, information acquired by the system, e.g., from the mobility tracker 24, may suggest that she frequently chooses to travel by car. In such a case, the profile manager 52 may infer that the user places a higher priority on saving time than on reducing her environmental impact. This is then reflected in her inferred goals 78.

3. Constraints 62: these include the user's constraints that have an impact on the identification of candidate itineraries 46. Example constraints may include the user makes use of a wheelchair, the user lacks a driver license, or the user cannot climb stairs, or the user will walk no more than X meters, or a combination thereof. Constraints can be expressed as Boolean values, e.g., a 0 when the constraint is not present, a 1 when it is. In some embodiments, only stated constraints 80 are used. In other embodiments, inferred constraints 82 may also be generated.

The system and method are thus able to take into account the general preferences 66 of the user, which can be explicitly stated by the user and/or learnt over time by the system, and the willingness of the user to change behavior, by defining a personal goal 76 or changing the preferences.

Regarding the user's stated preferences 72, users may have different attitudes with respect to the elicitation of the preferences. Some users may not be willing to explicitly declare their preferences. Others may be willing to express some of the preferences if, for example, they see an advantage to doing so, such as an improvement in the quality of the service. Still others may be willing to completely, even if gradually, define the stated elements of their profile. To address the different user attitudes, the user may be offered different profile selection mechanisms, such as: (1) not defining their profile at all; (2) choosing from among a set of stereotypes 84, which each correspond to a predefined profile that may then be tuned, if the user wishes to do so; and (3) defining their profile with the possibility of doing this incrementally and dynamically. The system will then use the stated preferences, if any, and modify them when there is a change in their definition.

The stereotypical profiles 84 can be predefined profiles corresponding to often observed situations, such as the user is in a hurry, is a student, is mobility or visually impaired, is a visitor, or the like. Predefined preferences and goals are associated with each stereotype and the itinerary ranking component 56 can rely on these predefined parameters for sorting the candidate itineraries in the same manner as for stated preferences and goals. A stereotypical profile 84 can be used as either a starting point for defining a user's profile or as an exceptional profile corresponding to the need for a specific trip, for example, when an unexpected event induces significant changes in the user's current preferences and goals, but the user plans to revert to the stated preferences and goals in the future. For example, the user may be in a hurry one day and therefore not wish to follow the predefined physical fitness goal that day.

Each stereotype profile 84 is a set of predefined preferences and goals, and the set of profiles and/or individual stereotypical profiles can be adapted to the collective needs of the users of the system. Some of the stereotypes may generally correspond to the set of possible goals, e.g.:

1. I want to save money: the sole goal of the user is to save money (reduce as much as possible the cost of the trips). Other stated goals are unused, preferences are given default values.

2. I want to save time: the sole goal of the user is to save time (reduce as much as possible the trip duration). Other stated goals are unused, preferences are given default values.

3. I want to increase my physical activity: the sole goal of the user is to increase his or her physical activity during the trips (e.g., by using a bicycle or walking. Other stated goals are unused, preferences are given default values (or only implemented under certain conditions, for example when distances and/or itinerary times are above thresholds);

4. I want to reduce my eco-impact: the sole goal of the user is to reduce her eco-impact by using a subset of the transportation modes that have lower environmental impact than others when feasible. Other stated goals are unused, preferences are given default values.

Stereotypes corresponding to common situations may also be defined:

1. I'm in a hurry: the user intends to travel as fast as possible. This is translated into all stated preferences and goals being unused, except the goal “save time” which is considered very important; all inferred goals may be set to 1.

2. I'm a student: the user is considered as having limited resources but willing to stay physically active. This is translated into two stated goals: “save money” (e.g., valued as “very important”) and “increase physical activity” (e.g., valued at “important”, because it may be considered slightly less important than saving money). Preferences are unused, inferred goals may be set to 1.

3. I'm mobility impaired: in this case, all stated goals and preferences may be unused, as well as inferred preferences. Inferred goals may be set to 1 and the system is configured for taking into account the constraint, e.g., “using wheelchair” and transmitting it in its requests to the trip planner 54.

FIG. 2 illustrates an exemplary computer-implemented method which can be performed with the system of FIG. 1. The method begins at S100.

At S102, the user may register with the system. The system provides for the user to state preference values 72 (directly or indirectly) for each of a plurality of transportation modes and provides for the user to state goal values 76 (directly or indirectly) for each of a plurality of goals to which the transportation modes employed in a given trip itinerary may contribute differently. The user then provides information which may be used to instantiate his or her profile with stated preferences 72 (e.g., with respect to one or more of the set of transportation modes), stated goals 76, and optionally constraints 80 which limit the transportation modes which can be used in a candidate itinerary. The user may grant access to the user's personal monitoring devices 24, 26, and/or provide other information used in ranking candidate itineraries, such as weight, age, etc.

At S104, a profile 36 is generated for the user by the profile manager 52, based on the provided information. The user profile 36 includes values for the inferred preferences and, where preferences have been stated by the user, a stated value for each of the preferences. The user profile 36 also includes values for the inferred goals and, where goals have been stated by the user, a stated value for each of the goals.

At S106, a trip request 40 is received from the registered user for planning a trip with a departure point D and an arrival point A.

At S108, constraints 62 are extracted from the user profile 36. In particular, the orchestration engine 50 calls the profile manager 52 for extracting the constraints 62 from the user's profile. Constraints can be explicit requests, e.g., the need for a wheelchair, or preferences concerning possible transportation modes when they are set to 0. For example, if car driving is set to 0, this means that the user does not want to use a car as a transportation mode. This preference is then converted to a constraint.

At S110, a list of candidate itineraries 46 from D to A is built. In particular, the orchestration engine 50 calls the trip planner 54, which builds a set of at least one (generally, at least two) candidate itineraries 46 between the two points, taking into account the user's constraints 62. The retrieved set of candidate itineraries for the trip which meet the user's constraints each specifies a respective set of the transportation modes.

At S112, the stated and inferred goals 76, 78 and preferences 72, 74 are aggregated. For example, the orchestration engine 50 calls the profile manager 52 for aggregating the stated and inferred goals 76, 78 for each goal and the stated and inferred preferences 72, 74 for each preference, e.g., using a weighting function which may incorporate a stated goal/preference coefficient (a forgetting factor) which takes into account the time 86 which has elapsed since that stated goal/preference was last set.

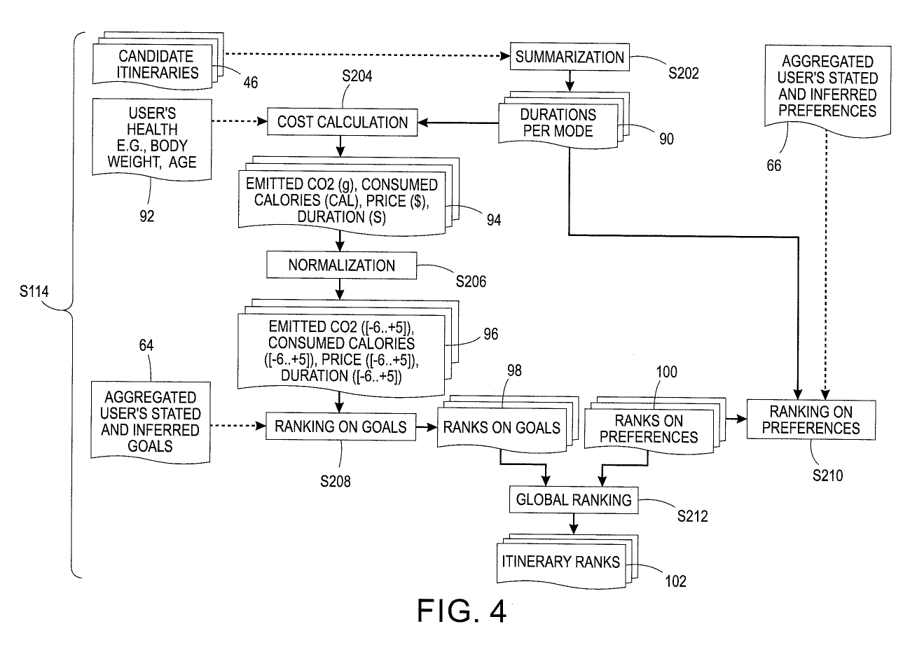

At S114, the candidate itineraries 46 are ranked based on the user profile 36, in particular, to optimize a function of the user's aggregated goals and preferences output at S112. For example, the orchestration engine 50 calls the ranking component 56, which ranks the set of candidate itineraries 46 suggested by the trip planner 54 according to the user's goals and preferences, as outlined in further detail below with respect to FIG. 4.

At S116, at least a subset 48 of the candidate itineraries is presented to the user as proposed itineraries. The system may also generate a representation of each trip itinerary in terms of how well it promotes the user's goals.

At S118, the user makes a selection of one of the proposed itineraries, which is received by the system. The selection is recorded by the profile manager 52 in memory for later computing of inferred goals and preferences 78, 74.

At S120, the system 10 optionally assists the user by providing navigation instructions for the selected itinerary. See, for example, Rehrl, K.; et al., “Assisting Multimodal Travelers: Design and Prototypical Implementation of a Personal Travel Companion”, Intelligent Transportation Systems, IEEE Trans. on Intelligent Transportation Systems, vol. 8, no. 1, pp. 31-42 (2007), in which the navigation instructions are designed to facilitate transfers.

At S122, the data acquisition component 60 optionally acquires data logged about the user's actual movements. This data collection can be made either by third party applications (e.g., a mobility tracker application 24 on the user's smartphone, which can automatically detect the transportation modes used by the user, e.g. based on speed, acceleration, and the like) or by dedicated devices (e.g., an activity tracker 26 such as a pedometer that the user carries with her). These data sources infer and collect data such as the likely transportation modes used (which may be refined based on the user's selected itinerary), the geolocation of the user, the number of steps that the user walked each day, and the like.

The method returns to S104, where the profile manager 52, using the recorded data acquired by the data acquisition component and the selected itinerary information, infers information related to the user's preferences and goals and updates the inferred preferences/goals 74, 78, as appropriate. For example, when the user selects an itinerary involving the use of a bicycle for the trip, the profile manager 52 can use the detected transportation modes for identifying if the user actually used a bicycle. If the user is deduced to have done so, this strengthens or maintains the inferred preference for the bicycle and, if not, it weakens this inferred preference. A forgetting factor may be used in updating the inferred preferences and goals to place more emphasis on recently acquired information than on less recently acquired information.

The system may then wait for a new trip request from the user (S106) and proceed as before.

The method ends at S126.

Further details of the system and method will now be described.

### Aggregating Goals and Preference Values (S112)

The stated and inferred values of a preference or a goal are combined, e.g., in a weighted combination, for defining a global value. The weights (coefficients) accorded to the inferred preferences/goals may increase with time on the assumption that more recently stated preferences/goals are more accurate than the corresponding values stated in the past. For example, the aggregated value cᵥ for a given criterion c (e.g., a preference or goal), e.g., to use the bus, may be aggregated as a function of the stated value C_{stated} and the inferred value c_{inferred} such as:

$${c}_{V} = \frac{{c}_{stated} * {w}_{stated} + {c}_{inferred} * {w}_{inferred}}{{w}_{stated} + {w}_{inferred}} , \qquad ( 1 )$$

or a function thereof, where the coefficient w_{inferred} for the inferred goal/preference may be a non-zero increasing function of the elapsed time since the value of the criterion (e.g., preference) was last stated (e.g., w_{inferred} may be a value which increases from a minimum to a maximum value (e.g., from 1 to 12 or from 0.5-6) over 12 months, putting greater weight on the inferred preference as time goes by), and the coefficient for the stated goal/preference w_{stated} may be a decreasing function of the elapsed time. Thus, when the user modifies one or more of his or her stated preferences, the weight of the corresponding inferred preference is reset to its minimum value (e.g., 1). The weight of an inferred goal is also reset to its minimum value (e.g., 1) when the user states one or more of his or her goals. This mechanism reflects the fact that the user may have information that the system does not have (yet) (e.g., the user may know that her car has broken down or that she wants to engage in more physical activity from now on).

The aggregated goals and preferences (at least for the transportation modes that are used in the candidate itineraries) are output by the aggregation component 55 to the ranking component 56.

Ranking of Candidate Itineraries (S114)

Various methods are contemplated for ranking the set of candidate itineraries 62 based on the set of the user's preferences and goals.

In one embodiment, for each candidate itinerary, a score is computed as an aggregate of a ranking of each of the criteria (preferences and goals). The score of each criterion can be a function, e.g., a product, of the criterion's aggregated value (computed at S112) and a measure of the criterion's contribution to the candidate itinerary, e.g., measured in terms of time. For example, the score S_{itinerary} for an itinerary is computed as a function of a sum for all the n criteria, of the criterion's aggregated value cᵥ (computed according to Eqn. 1), the unit cost cost_{c} of the criterion (in the case of goals) and/or the contribution t_{c} of that criterion to the candidate itinerary (e.g., measured in terms of time).

S_{itinerary}=Σ₁ⁿ(cᵥ*cost_{c}*t_{c}) (2),

or a function thereof.

The candidate itineraries can then be ranked based on their scores, e.g., the one with the highest score is ranked first, and so forth.

Such an objective function as shown in Eqn. 2 may be difficult to use in practice as the criteria may be measured using different scales. For example, for the goal of reducing environmental impact, the cost may be expressed in terms of carbon monoxide generated while for the fitness goal, it may be expressed as a function of calories consumed. There is thus no certainty that all parameters are comparable to each other (e.g., consider comparing and aggregating the physical activity and the pollution induced by a trip). In such a case, several objective functions may be employed, making it possible to create series of assessors on each considered criterion: a candidate itinerary is then evaluated as a set of indexes, of the form f(s)={Υ1(s), Υ2(s), . . . , Υn(s)}, where s is a candidate itinerary and Υi(s) is the result of the ith objective function assessing s on the ith criterion. The global ranking produces an aggregated rank ρ.

The comparison of several candidate itineraries can then be performed using various approaches, such as:

1. aggregation of the multiple objective functions in a single function (e.g., a weighted average) defining a complete preference order;

2. progressive definition of preference together with exploration of the feasible set;

3. definition of a partial order stronger than the product of the n complete orders associated with the n objective functions;

4. maximum reduction of uncertainty and incomparability.

See, for example, Roy, B. “Problems and methods with multiple objective functions,” Mathematical Programming, 1(1): 239-266 (1971).

In the ranking method illustrated in FIG. 4, a progressive method of refining the ranking is used to compute a utility function as an aggregation of multiple objective functions. It is applied to the set of candidate itineraries that are returned, by the trip planner, as an answer to a request of defining a trip from a departure point to an arrival point.

In particular the method computes the utility function by aggregating a first objective function that is a function of, for each of the goals, the aggregated goal weight and a respective computed (normalized) cost of the candidate itinerary, for that goal, and a second objective function that is a function of, for each of the preferences, the aggregated preference weight and a respective computed contribution for that preference, to the candidate itinerary. In the case of preferences for transportation modes, each contribution may be computed as a function of the total duration, in the itinerary, of travel by the respective transportation mode.

The following trip to go from the requester's home to her workplace will be used as an illustrative example:
A. Start from home at 7:15 AM
B. Walk to the parking place where the car is located, arrive at 7:25 AM
C. Drive to train station, arrive and park car at 7:40 AM
D. Take the train, arrive downtown at 7:50 AM
E. Take the tram at 7:52 AM, arrive at the destination station at 8:00 AM
F. Walk to the workplace, arrive at 8:07 AM.

This trip from home to the workplace in the example is a combination of the following transportation modes (in the order of the sequence): walk, car, train, tram, and walk.

As illustrated in FIG. 4, briefly, the ranking process may include summarization of candidate itineraries (S202), cost calculation for goals (S204), cost normalization (S206), ranking on goals (S208), ranking on preferences (S210), which may take place before, during, or after the ranking on goals, and global ranking, based on the ranking on preferences and ranking on goals (S212).

### Summarization

At S202, each candidate itinerary from the candidate set 46 provided by the trip planner is summarized. In particular, the ranking component computes the duration/distance of each transportation mode involved in the itinerary and its total duration, and total time of the trip, and optionally the total number of transfers. This mode duration information 90 is stored. Using the example itinerary, the information 90 may include:
Walking: 18 min, 1.2 km;
Driving: 15 min, 11 km;
Taking train: 10 min, 21 km;
Taking tramway: 8 min, 1.7 km;
Total itinerary duration: 52 min.

### Cost Calculation

At S204, a cost 94 that is induced by each of the transportation modes considered in each of the candidate itineraries is computed for each goal. The cost computation may depend on the distance, the duration, and the transportation mode. For each transportation mode, a specific formula may be defined for each goal. For example:

1. Calories consumed when walking=walked distance*user body weight (kg)*energy factor. The user body weight may be extracted from a user health record 92, or be an average over a population. The energy factor depends on the walking speed. See, for example, Didier, J.-P., et al., “Energy cost and cardiorespiratory responses while walking in two groups of young and elderly people”, Annales de Réadaptation et de Médecine Physique, Vol. 38, Issue 8, pp 475-480 (1995). For example, when walking at 0.8 m/s, the factor is equal to 1.042 kCal/kg/km. The walking speed may be derived from the activity tracker 26 during prior trips or more general walking by the user, may be computed based on the user's age stored in the health record 92, or be an average value, or take into account a combination of these factors.

2. Calories consumed when driving may be assumed to be approximatively 50 KCal per hour on top of the amount naturally burned each hour (e.g., a baseline of 80 kCal per hour), or computed based on the user's body weight. Such information may be obtained from a knowledge base or information available online. See, for example, https://www.exercise.com/activity/driving-car.

3. As sitting on a chair consumes no extra calories above the baseline, the calories consumed when being transported by tram, subway, or train is considered equal to 0.

4. Emitted CO₂ depends on the kind of carburant. For example, diesel fuel emits 2.6 kg CO₂ per consumed liter, liquefied petroleum gas (LPG) emits 1.66 kg, and super-unleaded petrol emits 2.28 kg CO₂. Such information may be obtained from a knowledge base or information available online. See, for example, http://www.ecoscore.be/en/how-calculate-co2-emission-level-fuel-consumption. The type of carburant may be assumed from the mode of transport used in the transportation system, or based on user-supplied information (e.g., the type of vehicle driven by the user, the grade of fuel used, the average gas mileage obtained, or the like).

4. Regional trains may be assumed to produce a standard value, e.g., 30.7 g of CO₂ per passenger per kilometer, on average (SNCF).

5. Monetary costs for public transportation may be obtained from the travel planning data 34. In the case of user-provided transport, such as car or bicycle, a fixed monetary cost per unit distance (which may depend on the vehicle's characteristics) may be assumed for each mode, and any fixed costs, such as parking fees/tolls, etc. that the user is likely to incur may also be considered.

As noted above, some of the costs may depend on the user's body weight and walk speed, others on the user's vehicle characteristics. As will be appreciated, approximations may be made to ease computation. In some cases, where the user has obtained a season pass for a transport mode or route (such as a tram pass), the cost for using that transportation mode or route may be considered as 0 or close to 0. Example results for the considered example are shown in TABLE 1.

TABLE 1
Costs Computed for the illustrative example of itinerary

| | CO₂ | | MONETARY | | | CONSUMED | |
|---|---|---|---|---|---|---|---|
| MODE | OUTPUT | | COST | DURATION | | CALORIES | |
| Walking | 0 | g. | $0.00 | 18 | min | 95 | kCal |
| Driving | 3582 | g. | $2.09 | 15 | min | 12 | kCal |
| Train | 645 | g. | $1.20 | 10 | min | 0 | kCal |
| Tram | 5.5 | g. | $0.00 | 8 | min | 0 | kCal |
| Total for | 4232.5 | g. | $3.29 | 52 | min | 107 | kCal |
| itinerary | | | | | | | |

### Normalization

At S206, the computed costs 94 for each of the goals are normalized to produce normalized costs 96 over a common range of values. This facilitates aggregation of the various costs and making them more comparable. The normalization may produce a value within a fixed range, the range being the same for each cost type. For example, normalization may produce a number between −5 (very bad) and +5 (very good) and optionally an additional value of −6 corresponding to a penalty when the cost is considered as unacceptable. The normalization may include a non-linear transform (e.g., an exponential function) or linear transform (e.g., a piece-wise linear function) of the costs onto the fixed range for comparing the costs of one itinerary to the costs of all the itineraries in the set of candidate itineraries.

For example, the itinerary of the example lasts 52 minutes. The best value for the duration is 32 minutes, by using only the car. The worst value for the duration is 67 minutes obtained by replacing the tram portion by walking. The average duration over the candidate set is 44 minutes. A reference value, which can be the average duration of commuting for people living in the same area and/or working nearby the user (57 minutes) may be used as a point. This provides four points of respectively 32, 44, 57, and 67 minutes, which can then be projected onto the range of normalized costs.

One example formula for computing the resulting normalized cost 96 is presented in TABLE 2. The aim is to associate a value to each of the reference points (the best one is scored +5, the second best is scored 0, the second worst is scored −5 and the worst is scored −6). Each line segment between two of these reference points can be used to compute normalized costs for intermediate values as the ordinate corresponding to the cost considered as an abscissa. The classical mathematical function y=ax+b is used for identifying y, which is the normalized cost of an un-normalized cost equal to x.

TABLE 2
Objective function for ranking based on the duration
of the illustrative example itinerary

| DURATION | NORMALIZED COST |
|---|---|
| duration ≦ 32 | +5 |
| 32 < duration < 44 | Normalized cost = a * duration + b |
| | Where a = (0 − 5)/(44 − 32) ≈ −0.42 |
| | b = 5 − 32a ≈ 18.3 |
| duration = 44 | 0 |
| 44 < duration < 57 | Normalized cost = a * duration + b |
| | Where a = (−5 − 0)/(57 − 44) ≈ −0.38 |
| | b = 0 − 44a ≈ 16.9 |
| duration = 57 | −5 |
| 57 < duration < 67 | Normalized cost = a * duration + b |
| | Where a = (−6 − −5)/(67 − 57) ≈ −0.1 |
| | b = −5 − 57a ≈ 0.7 |
| duration ≧ 67 | −6 |

The example itinerary lasting 52 minutes is ranked −3.08 on duration. The same kind of computation can be applied for CO₂, monetary cost, and consumed calories. All candidate itineraries are ranked in the same way, giving normalized costs as illustrated in TABLE 3 for the example itinerary and two alternative candidate itineraries.

TABLE 3
Normalized costs for candidate itineraries

| | | MONETARY | | CONSUMED |
|---|---|---|---|---|
| | CO2 | COST | DURATION | CALORIES |
| Example itinerary | −1.28 | +3.53 | −3.08 | −2.67 |
| Alternative #1 | +5 | +5 | −6 | +5 |
| Alternative #2 | −5 | −5 | +5 | −6 |

As will be appreciated other methods of converting costs expressed in different units to a normalized common range may be used.

### Ranking on Goals

In S208, the normalized costs are aggregated according to the user's goals. Goals might be undefined (this is implemented as a 0) or be defined with values between 1 (“not an important objective to me”) and 5 (“a very important objective for me”). As noted above, the system may consider stated and/or inferred goals. For example, the user declares that he wants to reduce his environmental impact (goal “reduce eco-impact”: +5) even if it takes more time (goal “save time”: +2). However, if the system identifies that he always chooses the quickest itinerary, the system then may infer that his main objective is to save time (inferred goal “save time”: +5) and seems to pay attention to CO2 only when two itineraries require the same time (inferred goal “reduce eco-impact”: +2).

Moreover, goals may have a deadline (“I want to increase my physical activity before March the 30^{th}”). In such a case, the goal is no longer taken into account after the deadline (its value is reset to 0). Before the deadline, it is included in the calculation. In one embodiment, the importance of the goal may be considered as increasing when the deadline comes closer. This functionality could be implemented by modifying the inferred value of the goal linearly between the date when it was set and the deadline. For example, if the user says on January 1^{st} that she wants to increase her physical activity before March 30^{th}, and indicates this goal has a stated value of 3, the system could consider that the goal has a linearly increasing value starting with 3 on January 1^{st} and increasing to 5 on March 30^{th}.

For ranking itineraries on goals, the values for the stated and inferred goals 76, 78 are first aggregated at S112. The way the data are aggregated may depend on the estimated validity of the values. For instance, if the user stated his goals recently, the stated values are the most valid ones. But if the declaration has been made a long time ago and if there is relevant history since this declaration, the inferred goals, calculated from this history, are likely to be more valid than the declaration. The result is a weighted average, where the weights (coefficients) depend on the validity.

As an example, goal coefficients may be defined on a yearly basis. For example each coefficient has value between minimum and maximum values, such as from 1 to 12. For example, the coefficient of stated goals is 12 when they just have been stated and linearly decreases over one year with the number of months since the declaration. After six months, their coefficient is 6. On the other hand, the coefficient of each of the inferred goals is 1 when a goal declaration has just been made and then linearly increases during one year to a maximum value (a reset is made when stated goals are modified).

The aggregate goal value can then be computed as:

$$( Stated goal \times \frac{wt of stated goal}{maximum wt} ) + ( Inferred goal \times \frac{wt of inferred goal}{maximum wt} )$$

which may be rounded up to the nearest integer.

TABLE 4 shows example computation of aggregated goal values (S112) to be used in the ranking process, as a function of stated and inferred goals.

TABLE 4
Example of stated and inferred goals with the resulting
aggregated goal weights to be used in itineraries ranking

| | REDUCE | | | INCREASE |
|---|---|---|---|---|
| | ECO- | SAVE | SAVE | PHYSICAL |
| | IMPACT | MONEY | TIME | ACTIVITY |
| Stated goal | +5 | 0 | +2 | 0 |
| Coefficient of stated goal | 8 | 8 | 8 | 8 |
| Inferred goal | +2 | +1 | +5 | +1 |
| Coefficient of | 4 | 4 | 4 | 4 |
| inferred goal | | | | |
| Aggregated goal weight | 4 | 1 | 3 | 1 |

The ranking of an itinerary on a given goal is based on the normalized cost of the itinerary for this goal. For example, the ranking of an itinerary on the goal “saving time” is based on the normalized duration of the itinerary, whose value is greater than −6 (the value for the duration that is considered as being very bad) and lower than +5 (the value for the duration that is considered as being very good).

The ranking on goals 98 for each candidate itinerary can be computed by using Equation 3 (goals taken into account here are those with an aggregated value of greater than 0):

$$ItineraryRankOnGoals = \frac{{\sum }_{goals} normalizedCost ( goal ) * goal weight}{{\sum }_{goals} goal weight} \qquad ( 3 )$$

where: goals is the set of goals defined for the application;
goal weight corresponds to a value between 1 and 5 (e.g., save money=2), which is the aggregation of the stated and inferred values; and
normalizedCost(goal) is the normalized cost 96 of the parameter(s) corresponding to the goal (e.g., for the goal of saving money, the normalized monetary cost=+3.53).

For example, the rank of the itinerary on goals in the example could then be:

$$\frac{\begin{matrix}( ecocost * eco wt ) + ( moncost * mon wt ) + \\ ( durcost * dur wt ) + ( fit cost * fit weight )\end{matrix}}{eco wt + mon wt + dur wt + fit weight} = \frac{( –1 .28 * 4 + 3.53 * 1 + –3 .08 * 3 + –2 .67 * 1 )}{( 4 + 1 + 3 + 1 )} = –1 .5$$

where ecocost is the normalized cost for the environmental goal (reducing CO2), and eco wt is the aggregated weight of this goal,

moncost is the normalized cost for the saving money goal (reducing monetary cost), and mon wt is the aggregated weight of this goal,

durcost is the normalized cost for the duration goal (saving time), and dur wt is the aggregated weight of this goal,

fitcost the normalized cost for the fitness goal (increasing calorie consumption), and fit wt is the aggregated weight of this goal.

TABLE 5 shows the ranks on goals computed according to Eqn. 3 for three candidate itineraries, where the first row corresponds to the illustrative example used above, the second row shows values for Alternative #1 that corresponds to an itinerary using the bicycle, and the third row shows values for Alternative #2 that corresponds to an itinerary using the car.

TABLE 5
Example of ranking with goals (as defined in Table 4)

| | NORMALIZED | NORMALIZED | NORMALIZED | NORMALIZED | RANK |
|---|---|---|---|---|---|
| | CO₂ | MONETARY | DURATION | CALORIES | WITH |
| MODE | COST | COST | COST | COST | GOALS |
| Example itinerary | −1.28 | +3.53 | −3.08 | −2.67 | −1.5 |
| Alternative #1 | +5 | +5 | −6 | +5 | −0.080 |
| Alternative #2 | −5 | −5 | +5 | −6 | −2.596 |

### Ranking on Preferences

As discussed above, several preferences can be defined. Each of them can be treated in the same way, except for the preference on walking. It is assumed that every itinerary includes at least some walking, for example, for going from the starting point of the trip, that is, the departure point, to the closest station or to the car's parking place. If the user states that he wants to avoid walking, only itinerary stages excluding the first and last ones are considered to be influenced by this preference.

As for the goals, the preferences can be stated and inferred. The same algorithm of coefficients evolving over time defined for the goals can be used for the preference aggregation at S112. TABLE 6 shows an example of stated and inferred preferences aggregation, where stated preferences have a coefficient of 10 and inferred preferences have a coefficient of 2.

TABLE 6
Aggregating Preference Values

| | PREFERENCE | PREFERENCE | PREFERENCE | PREFERENCE | PREFERENCE |
|---|---|---|---|---|---|
| | WALKING | DRIVING | TRAMWAY | BICYCLE | TRAIN |
| Stated | 5 | undefined | 4 | 5 | 4 |
| value | | | | | |
| Inferred | 1 | 4 | 1 | 2 | 5 |
| value | | | | | |
| Agg. | 4.33 | 4.00 | 3.50 | 4.50 | 4.17 |
| preference | | | | | |
| weight | | | | | |

The calculation of the ranking 100 of an itinerary's stage on mode preferences can be computed with a second objective function according to Eqn. (4):

$$ItineraryRankOnPrefs = \frac{{\sum }_{modes} ( \begin{matrix}if {p}_{mode} = 0 then –∞ , otherwise \\ ( 1 - \frac{max D ( mode ) - d ( mode )}{max D ( mode )} ) * {p}_{mode}\end{matrix} )}{number of modes} \qquad ( 4 )$$

where:

modes is the set of transportation modes involved in the itinerary;

pmode is the preference for the mode of the stage, i.e., the weighted aggregate of stated and inferred preferences computed according to Eqn. 1:

$$pmode = \frac{( pStatedmode * wStatedPref + pInferredmode * wInferredPref )}{( wStatedPref + wInferredPref )} ;$$

maxD (mode) is the maximum duration of a mode over the set of itineraries;

d(mode) is the total duration of the mode; and

number of modes is the number of transportation modes that are involved in the itinerary.

If pmode is 0 it means the user would not want to use that mode in the trip, so the entire itinerary receives a very low value by assigning that mode a very negative value, such as −∞. TABLE 7 shows the ranking on preferences as defined in TABLE 6.

TABLE 7
Ranking on preferences defined in TABLE 6

| | WALK | DRIVING | TRAM | BICYCLE | TRAIN | RANK WITH |
|---|---|---|---|---|---|---|
| | DURATION | DURATION | DURATION | DURATION | DURATION | PREFERENCES |
| Example | 18 | 15 | 8 | 0 | 10 | 2.495 |
| itinerary | | | | | | |
| Alternative #1 | 0 | 0 | 0 | 85 | 0 | 4.769 |
| Alternative #2 | 0 | 32 | 0 | 0 | 0 | 4.000 |
| maxD(mode) | 18 | 32 | 8 | 85 | 10 | |

### Final Ranking

Final (global) ranking (S212) can be a weighted average of ranking on goals and ranking on preferences. Each (or at least some) of the candidate itineraries thus receives a final ranking 102 (or score, which may be converted to a ranking). The weights may depend on the relative importance of goals and preferences. In an example embodiment, goals are considered to be more important than the preferences. In this case goals have a higher weight than preferences, e.g., goals have weight of 2 and preferences have a weight of 1.

TABLE 8 shows an example of final ranking.

TABLE 8
Example of final ranking

| | RANK | RANK | | |
|---|---|---|---|---|
| | WITH | WITH | FINAL | |
| | PREFS | GOALS | RANKING | INTERPRETATION |
| Example | 2.497 | +2.947 | +2.796 | This multimodal itinerary lasts 51 min |
| itinerary | | | | and involves walking, tram and train, |
| (walk, drive, | | | | which are low on CO2. The car is |
| train, tram) | | | | used briefly. This is a good balance |
| | | | | between reducing eco-impact (very |
| | | | | important) and saving time |
| | | | | (important). |
| Alternative | +4.769 | −0.942 | +0.962 | This itinerary produces no CO2. |
| #1 (bicycle) | | | | However, it lasts 85 min and thus |
| | | | | doesn't match the very important |
| | | | | inferred goal of saving time. |
| Alternative | −1.564 | +4.000 | +0.290 | This itinerary responds well to the |
| #2 (drive) | | | | goal of saving time, but doesn't |
| | | | | match the other stated and inferred |
| | | | | goals or the preferences (the inferred |
| | | | | preference for driving is low). |

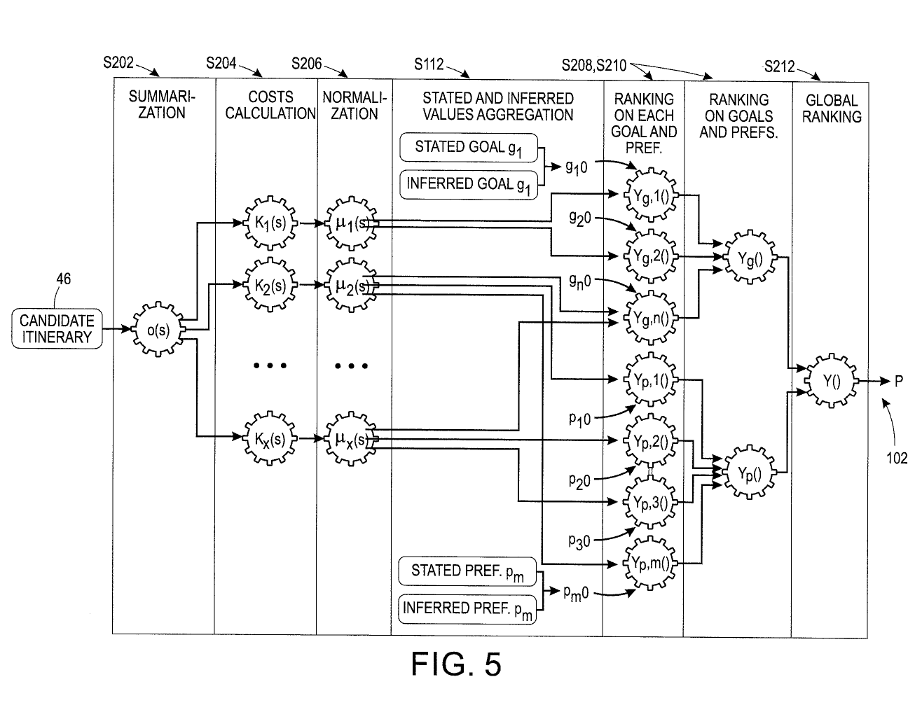

FIG. 5 illustrates the exemplary utility function employed herein as an aggregation of the multiple objective functions.

The method illustrated in FIGS. 2 and 4 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer 30, (for example, an internal hard drive of RAM), or may be separate (for example, an external hard drive operatively connected with the computer 30), or may be separate and accessed via a digital data network such as a local area network (LAN) or the Internet (for example, as a redundant array of inexpensive of independent disks (RAID) or other network server storage that is indirectly accessed by the computer 30, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIGS. 2 and/or 4, can be used to implement the trip ranking method. As will be appreciated, while the steps of the method may all be computer implemented, in some embodiments one or more of the steps may be at least partially performed manually. As will also be appreciated, the steps of the method need not all proceed in the order illustrated and fewer, more, or different steps may be performed.

### Mixing Statement and Learning of Preferences and Goals

The exemplary system and method thus provide a profile scheme and a ranking function that can take into account evolution of the user's preferences and goals, and can also accommodate major changes.

When user preferences are stable, learning techniques, such as those proposed in Arentze, T. A., “Adaptive Personalized Travel Information Systems: A Bayesian Method to Learn Users' Personal Preferences in Multimodal Transport Networks”, IEEE Trans. on Intelligent Transportation Systems, vol. 14, no. 4. (2013). and Zhang, J., et al., “Personalized multi-modal route planning: a preference measurement and learning-based approach,” Proc. 11th Intl Conf. on Mobile and Ubiquitous Systems: Computing, Networking and Services, pp. 338-344 (2014), can be used to infer preferences from user travel choices. The inferred preferences tend to be more accurate than stated preferences, particularly when a learning phase involving acquisition of a certain amount of data is used. However, in such an approach, the amount of historical data weighs on the current inferred preferences and a change in the behavior of the user will only be fully taken into account after a certain amount of time (and choices).

The present method, which considers stated goals and preferences as well as inferred ones, enables the system to take into account the user's aspirations for change and also consider exceptional situations, at a stage well before a standard learning approach could update the inferred preferences. By increasing inferred values' coefficients over time after a statement, the increased accuracy of the inferences can be taken into account.

In addition, stating goals and preferences can enable the system to deal with sudden events that impact the trip (e.g., this week, the user has more time and will favor biking over car, which she usually prefers).

The following examples illustrate that the system can give a relevant ranking of candidate itineraries in different use cases:

### Example 1

### Initial Situation, No Preferences or Goals are Stated or Inferred

In this situation, a set of default values for the stated preferences are established and stated goals are considered all equal to 0, except for the goal on saving time that is set to 1 (corresponding to the assumption that if not otherwise specified, a user would like to save time).

### Example 2

### Some Preferences and Goals are Inferred

The user has made at least one choice about her trips and the system uses this data as well as the trip logs 70 for inferring the user's preferences and goals. For example, the system knows that the user generally prefers using her car (inferred preference ‘driving’ is set to 5, all other preferences are unknown) and aims at saving time (inferred goal ‘save time’ is set to 5, all other goals are left to 1). The system uses these inferred values for ranking the future requested trips.

### Example 3

### One Goal is Stated

The user states a goal. This resets the coefficients for inferred goals (in order to take into account the new data) and does not change those of the preferences.

### Example 4

### Some Preferences are Stated

The user states some preferences or changes some of them. Then the system resets the inferred preferences coefficients to 1 (and the coefficient of stated preferences is set to 12), as it considers that the user wants to change the system results. This mechanism gives the application the time to adapt to the new situation.

### Example 5

### Ranking Candidate Itineraries in an Exceptional Situation

The user is in a specific situation, which can correspond to an exceptional event, e.g., the usual transportation mode is not available or the user is in a hurry. Then, the user needs to use specific criteria corresponding to the situation and therefore selects a stereotypical profile 84. The preferences and goals associated to this profile are then used instead of the user's preferences and goals. In this specific case, the preferences are all set to “unknown” (except preferences that were set to 0 (meaning that the user really doesn't want to use the corresponding transportation mode: such preferences are considered as constraints, e.g. the user can't walk a long time and expresses this in her preferences), and thus are not modified. All goals are set to “undefined” (0), except the goal “save time”, which is set to “very important” (5). Inferred goals are all set to 1 for breaking ties.

### Example 6

### User without Preference but with a Goal

In this case, the user has not expressed any preferences, but has specified at least one goal. In such a case, the stated preferences are not taken into account and the ranking module takes into account only the inferred preferences (if available) and the stated and inferred goal(s).

### Example 7

### Complete Self-Description

In this case, the user has completely filled in the stated preferences and goals of the user profile 36. The system considers both the stated and the inferred parameters in the ranking process, but considers the inferred parameters less important than the stated parameters. A change in stated preferences may occur at any time, resetting the inferred parameter coefficients. It can for example correspond to a user buying a bicycle and now wishing to use it or to someone whose physician has advised them to increase daily walking activity and who will set new preferences accordingly, expecting them to be taken into account immediately.

Some examples are now given of how the system reacts over time adapting itself to the following sequence of situations.
A. The user starts using the system without stating her preferences and goals;
B. After a while, the system has inferred the user's preferences and goals: the user generally prefers using the car and wants to save time;
C. The user states a goal, that is reducing eco-impact;
D. The user states some preferences: setting the bicycle to a high level of preference and the car to a low level;
E. Today the user is in a hurry

These various situations are considered in the ranking of the same set of itinerary alternatives for a requested trip from home to workplace:
1. Walking from home to the closest tram station (5 min), taking tram B (15 min), walking from the tram station to the user's workplace (3 min).
2. Walking from home to the closest bus station (7 min), taking bus 21 (4 min), waiting for bus 47 (4 min), taking bus 47 (5 min), walking from the bus station to the user's workplace (1 min).
3. Walking from home to the car's parking space (1 min), driving to the workplace (9 min), walking from parking space to the workplace (1 min).
4. Using bicycle from home to the workplace (17 min).
5. Walking from home to the workplace (46 min).

The costs corresponding to the alternatives are shown in TABLE 9.

TABLE 9
Alternatives and costs

| | | Dura- | | Mone- | |
|---|---|---|---|---|---|
| | | tion | CO₂ | tary | Calo- |
| | Description | (min) | (g) | Cost ($) | ries |
| Alt. #1 | Walk → Tram (8 km) → Walk | 18 | 25 | 1.5 | 46 |
| Alt. #2 | Walk → Bus (3.9 km) → Bus | 21 | 495 | 1.5 | 46 |
| | (4.8 km) → Walk | | | | |
| Alt. #3 | Walk → Car | 11 | 1706 | 1.3 | 13 |
| | (4.2 km) → Walk | | | | |
| Alt. #4 | Bicycle (4.1 km) | 17 | 0 | 0.0 | 135 |
| Alt. #5 | Walk (3.8 km) | 46 | 0 | 0.0 | 264 |

After normalization, the costs are as shown in TABLE 10.

TABLE 10
Normalized Costs

| | | | | Mone- | |
|---|---|---|---|---|---|
| | | Dura- | | tary | Calo- |
| | Description | tion | CO₂ | Cost | ries |
| Alt. #1 | Walk → Tram | 1.983 | 4.719 | −5.000 | −3.121 |
| | (8 km) → Walk | | | | |
| Alt. #2 | Walk → Bus | 0.690 | −0.197 | −5.000 | −3.121 |
| | (3.9 km) → Bus | | | | |
| | (4.8 km) → Walk | | | | |
| Alt. #3 | Walk → Car | 5.000 | −5.000 | −3.438 | −5.000 |
| | (4.2 km) → Walk | | | | |
| Alt. #4 | Bicycle (4.1 km) | 2.414 | +5.000 | +5.000 | +1.048 |
| Alt. #5 | Walk (3.8 km) | −5.000 | +5.000 | +5.000 | +5.000 |

Considering the sequence of situations A-E in the example, at the beginning the user has expressed no preferences or goals and only the inferred goal on saving time is set to 1. In this situation, neither the preferences nor the stated goals are taken into account as shown in TABLE 11.

TABLE 11
Case A

| | | Rank on | Rank on | Global |
|---|---|---|---|---|
| | Description | Prefs | Goals | Rank |
| Alt. #1 | Walk → Tram (8 km) → Walk | N/A | −0.355 | −0.355 |
| Alt. #2 | Walk → Bus (3.9 km) → Bus | N/A | −1.907 | −1.907 |
| | (4.8 km) → Walk | | | |
| Alt. #3 | Walk → Car (4.2 km) → Walk | N/A | −2.109 | −2.109 |
| Alt. #4 | Bicycle (4.1 km) | N/A | +3.365 | +3.365 |
| Alt. #5 | Walk (3.8 km) | N/A | +2.500 | +2.500 |

According to these results, alternative #4 (using bicycle) is proposed as the best option, as its duration (17 min) is close to the best duration (11 min) and it minimizes the monetary cost, the eco-impact and leads to more physical activity than using tram, bus or car. The itinerary relying only on walking lasts so much longer that it is considered worse than using the bicycle.

However, the user chooses to use the car. The system thus infers first values for user's preferences and goals: that the user prefers using her car (inferred preference ‘driving’ is set to 5, all other preferences are unknown) and aims at saving time (inferred goal ‘save time’ is set to 5, all other inferred goals are left to 1), as shown in TABLE 12.

TABLE 12
Case B

| | | Rank of | Rank on | Global |
|---|---|---|---|---|
| | Description | Prefs | Goals | Rank |
| Alt. #1 | Walk → Tram (8 km) → Walk | N/A | +1.515 | +1.515 |
| Alt. #2 | Walk → Bus (3.9 km) → Bus | N/A | +0.170 | +0.170 |
| | (4.8 km) → Walk | | | |
| Alt. #3 | Walk → Car (4.2 km) → Walk | +5.000 | +3.578 | +4.052 |
| Alt. #4 | Bicycle (4.1 km) | N/A | +2.604 | +2.604 |
| Alt. #5 | Walk (3.8 km) | N/A | −3.500 | −3.500 |

The best option proposed with these parameters is alternative #3, which corresponds to the inferred goal of saving time (it is the quickest one) and to the inferred preference of driving.

Then the user states a goal value of 3 for reducing eco-impact. This resets the inferred goals to the same value as the stated goals (or 1 for the non-stated goals), resets the stated goals coefficients to 12 and the inferred goals coefficient to 1 and does not change the preferences. The goals values are then (stated/inferred): save money=(0/1), save time=(0/1), reduce eco-impact=(3/3), increase physical activity=(0/1) as shown in TABLE 13.

TABLE 13
Case C

| | | Rank of | Rank on | Global |
|---|---|---|---|---|
| | Description | Prefs | Goals | Rank |
| Alt. #1 | Walk → Tram (8 km) → Walk | N/A | +3.028 | +3.028 |
| Alt. #2 | Walk → Bus (3.9 km) → Bus | N/A | −0.767 | −0.767 |
| | (4.8 km) → Walk | | | |
| Alt. #3 | Walk → Car (4.2 km) → Walk | +5.000 | −4.036 | −1.024 |
| Alt. #4 | Bicycle (4.1 km) | N/A | +4.455 | +4.455 |
| Alt. #5 | Walk (3.8 km) | N/A | +4.167 | +4.167 |

The alternative by car is no longer the best one as saving time is no longer the main goal. Two alternatives make it possible to reduce eco-impact: using the bicycle and walking. As walking is much longer than using a bicycle, the best option is now alternative #4.

The user states some preferences: setting the tram to a high level and expresses a total dislike for using the bicycle. As already mentioned, when the user states or redefines her preferences, the system resets the inferred preferences coefficient to 1 (and the coefficient of stated preferences is set to 12), as it considers that the user wants to change the system results. This mechanism gives to the application the time to adapt to the new situation. The values of the preferences (stated/inferred) is now: driving (undefined/5), using tram (5/undefined), using bicycle (0/undefined) as shown in TABLE 14.

TABLE 14
Case D

| | | Rank of | Rank on | Global |
|---|---|---|---|---|
| | Description | Prefs | Goals | Rank |
| Alt. #1 | Walk → Tram (8 km) → Walk | +5.000 | +3.028 | +3.685 |
| Alt. #2 | Walk → Bus (3.9 km) → Bus | N/A | −0.767 | −0.767 |
| | (4.8 km) → Walk | | | |
| Alt. #3 | Walk → Car (4.2 km) → Walk | +5.000 | −4.036 | −1.024 |
| Alt. #4 | Bicycle (4.1 km) | −∞ | +5.000 | −∞ |
| Alt. #5 | Walk (3.8 km) | N/A | 4.167 | +4.167 |

The best option in this context is then alternative #5. While option #1, using tram, is a transportation mode that the user has expressed liking, it is not the most highly-ranked option, since the user also expressed a goal of reducing her eco-impact. Using the tram is more polluting than walking: the combination of the various criteria places the walk as the optimal option. If the user prefers using the tram to walking, the user can, of course, state it explicitly by defining her preference value for walking or expressing the goal of saving time. However, even if the user does not do so, after a little time, the system will infer that the user does not like to walk (for instance, the user chooses to use the tram each time) and the inferred preferences will modify this ranking.

The user is in a hurry and she selects the corresponding stereotypical profile “In a hurry”. The preferences and goals associated to this profile are used instead of the user's preferences and goals. In this specific case, the stated and inferred preferences are all set to “undefined” (except for those preferences that were set to 0, meaning that the user really does not want to use the corresponding transportation mode: such preferences are considered as constraints. In the example case, using bicycle remains considered as totally undesired and will not be modified). All stated goals are set to “undefined” (0), except the goal “save time”, which is set to “very important” (5), inferred goals being all set to 1, as shown in TABLE 15.

TABLE 15
Case E

| | | Rank of | Rank on | Global |
|---|---|---|---|---|
| | Description | Prefs | Goals | Rank |
| Alt. #1 | Walk → Tram (8 km) → Walk | N/A | +1.485 | +1.485 |
| Alt. #2 | Walk → Bus (3.9 km) → Bus | N/A | +0.136 | +0.136 |
| | (4.8 km) → Walk | | | |
| Alt. #3 | Walk → Car (4.2 km) → Walk | N/A | 3.485 | +3.485 |
| Alt. #4 | Bicycle (4.1 km) | −∞ | 2.616 | −∞ |
| Alt. #5 | Walk (3.8 km) | N/A | −3.402 | −3.402 |

Then the best option is alternative #3, using the car: this is indeed the quickest one.

The method for ranking itineraries can be implemented as a Web site. The ranking function can be written, for example in JavaScript. It accepts as input a set of candidate itineraries, e.g., as suggested by the trip planner of U.S. application Ser. No. 14/450,628, and executes all steps describes above, producing a rank for each suggested itinerary.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for assisting a user in planning a trip comprising:
receiving a request for a trip from a user;
accessing a user profile for the user, the user profile including user preferences for each of a plurality of transportation modes, user goals, and optionally user constraints on trips, the user preferences each including an inferred user preference value and, where stated, a stated user preference value; and the user goals each including an inferred user goal value and, where stated, a stated user goal value;
building a set of candidate itineraries for the trip which meet the user's constraints, the candidate itineraries each specifying a respective set of the plurality of transportation modes;
for each of the user preferences, aggregating the stated preference value, where stated, and the inferred preference value to generate a weight for the preference;
for each of the user goals, aggregating the stated goal value, where stated, and the inferred goal value to generate a weight for the goal;
for each of the candidate itineraries, computing a cost for each of the goals;
with a processor, for each of the candidate itineraries, ranking the itinerary based on the preference weights, goal weights, and the computed cost for each of the goals; and
outputting information on at least a subset of the ranked itineraries for enabling the user to select an itinerary for the trip.

2. The method of claim 1, wherein the ranking includes computing a utility function as an aggregation of a plurality of objective functions, the plurality of objective functions including:
a first objective function that is a function of, for each of the goals, the goal weight and the respective computed cost of the candidate itinerary, for that goal; and
a second objective function that is a function of, for each of the user preferences, the preference weight and the computed contribution of the respective mode of transportation to the candidate itinerary.

3. The method of claim 1, wherein contribution of the respective mode of transportation is computed as a function of at least one of duration and distance in the itinerary of that transportation mode.

4. The method of claim 1, wherein in the aggregating of the stated preference value and the inferred preference value to generate a weight for the preference, includes computing a coefficient for at least one of the stated preference value and the inferred preference value, the coefficient being a function of a duration since the preference was last stated.

5. The method of claim 1, wherein in the aggregating of the stated goal value and the inferred goal value to generate a weight for the goal, includes computing a coefficient for at least one of the stated goal value and the inferred goal value, the coefficient being a function of a duration since the goal was last stated.

6. The method of claim 1, wherein the computing a cost for each of the goals includes projecting a computed cost related to the goal onto a common range of values.

7. The method of claim 1, wherein the goals include goals selected from a fitness goal, a cost saving goal, a time saving goal, and an environmental impact goal.

8. The method of claim 1, wherein the cost for each goal is computed as a function of a different respective variable.

9. The method of claim 1, wherein the cost for a fitness goal is computed as a function of computed calories consumed, the cost for a money saving goal is computed as a function of a computed monetary cost of the itinerary, the cost for a time saving goal is computed as a function of a computed duration of the itinerary, and the cost for an environmental impact goal is computed as a function of a computed CO₂ output.

10. The method of claim 1 wherein the transportation modes include modes selected from the group consisting of walk, bicycle, tram, bus, train, and personal vehicle.

11. The method of claim 1, wherein the transportation modes include at least one public transportation mode and at least one personal transportation mode.

12. The method of claim 1, wherein at least one of the constraints places a limit on use of one of the transportation modes from the plurality of transportation modes for building the set of candidate itineraries.

13. The method of claim 1, further comprising updating at least one of the user's inferred preferences and inferred goals based on information received from at least one of a mobility tracker and an activity tracker associated with the user.

14. The method of claim 1, further comprising updating at least one of the user's inferred preferences and inferred goals based on the user's selected itinerary.

15. The method of claim 1, further comprising providing a set of stereotypical profiles and wherein when a user selects one of the stereotypical profiles, modifying at least one of the user's goals and the user's preferences for the trip.

16. The method of claim 1, further comprising providing for the user to state preferences and goals and updating the user profile based on the stated preferences and goals.

17. A computer program product comprising a non-transitory recording medium storing instructions, which when executed on a computer, causes the computer to perform the method of claim 1.

18. A system for planning a trip comprising memory which stores instructions for performing the method of claim 1 and a processor in communication with the memory for executing the instructions.

19. A system for planning a trip comprising:
a profile manager which manages, for each of a plurality of users, a respective user profile, the user profile including the user's preferences for each of a plurality of transportation modes, user goals, and optionally user constraints on trips, the user preferences each including an inferred user preference value and, where stated, a stated user preference value, and the user goals each including an inferred user goal value and, where stated, a stated user goal value;
a trip planner which builds a set of candidate itineraries for a trip requested by one of the users, which meet the user's constraints on trips, the candidate itineraries each specifying a respective set of the plurality of transportation modes;
an aggregation component which, for each of the user preferences, aggregates the stated preference value, where stated, and the inferred preference value to generate a weight for the preference and for each of the user goals, aggregates the stated goal value, where stated, and the inferred goal value to generate a weight for the goal;
a ranking component which ranks the candidate itineraries for each of the candidate itineraries based on the preference weights, goal weights, and a computed cost for each of the preferences and of the goals;
a representation generator which outputs information on at least a subset of the ranked itineraries for enabling the user to select an itinerary for the trip; and
a processor which implements the profile manager, trip planner, aggregation component, ranking component, and representation generator.

20. The system of claim 19, further comprising an update component which updates the user's inferred preferences and inferred goals based on at least one of:
information received from at least one of a mobility tracker and an activity tracker associated with the user; and
the user's selected itinerary.

21. A method comprising:
providing for a user to state preference values for each of a plurality of transportation modes;
providing for the user to state goal values for each of a plurality of goals to which the transportation modes employed in a trip itinerary contribute differently;
optionally, providing for the user to state a constraint for at least one of the transportation modes;
generating a user profile for the user, the user profile including user preferences for each of a plurality of transportation modes, user goals, and optionally user constraints on trips, the user preferences each including an inferred user preference value and, where stated, the stated user preference value, and the user goals each including an inferred user goal value and, where stated, the stated user goal value, the inferred user goal values and inferred user preference values being based on prior user behavior;
for each of a set of candidate itineraries for a trip, ranking the candidate itinerary, the ranking comprising computing a utility function which takes into account the stated and inferred preferences and stated and inferred goals and coefficients which place a weight on the inferred goals and inferred preferences as a function of a duration since the respective goal or preference was last stated; and
outputting information based on the ranking; and
wherein the generating a user profile and ranking the candidate itineraries is performed with a processor.
